(19) United States
(12) Patent Application Publication
(10) Pub. No.: US 2023/0403495 A1
(43) Pub. Date: Dec. 14, 2023

(54) EARPHONE AND ACOUSTIC CONTROL METHOD

(71) Applicant: PANASONIC INTELLECTUAL PROPERTY MANAGEMENT CO., LTD., Osaka (JP)

(72) Inventor: Naotaka KUSUI, Fukuoka (JP)

(21) Appl. No.: 18/334,005

(22) Filed: Jun. 13, 2023

(30) Foreign Application Priority Data
Jun. 13, 2022 (JP) 2022-095153

(51) Int. Cl. H04R 1/10

(52) U.S. Cl. CPC H04R 1/1041; H04R 1/1016; H04R 1/1075; H04R 1/1083; H04R 2460/11; H04R 2410/07

(57) ABSTRACT

An earphone includes a housing having a space therein and a path capable of ventilation from one end side on an external auditory canal side of a wearer to the other end side on an ambient environment side, a valve switching the path between an open state and a close state, a first microphone collecting an external sound on the ambient environment side, a second microphone collecting an uttered voice of the wearer, and a control unit controlling the open state and the close state. The control unit switches the path between the open state and the close state in accordance with an operation mode, and maintains or switches the path in or to the close state in a case where it is determined that a sound signal collected by the microphone and the second microphone during the operation mode is a wind noise.

### CROSS-REFERENCE TO RELATED APPLICATIONS

This application is based on and claims priority under 35 USC 119 from Japanese Patent Application No. 2022-095153 filed on Jun. 13, 2022, the entire content of which is incorporated herein by reference.

### TECHNICAL FIELD

The present disclosure relates to earphones, an acoustic control method, and a program.

### BACKGROUND ART

Patent Literature 1 discloses earphones that can be connected to a device such as a mobile phone. The earphones include a housing that is shaped and configured so as to substantially cover an external auditory canal, that accommodates a speaker element which emits sound to the external auditory canal, and that includes a channel extending from an inner end facing an external auditory canal side to an outer end facing a peripheral side, and a closing unit that switches between a closed state in which the channel is substantially closed and an opened state in which the channel transmits a sound from the periphery. The earphones are automatically switched to the opened state when the device is in a phone operation mode, and are automatically switched to the closed state when the device is in an audio player operation mode.

### CITATION LIST

### Patent Literature

Patent Literature 1: JP2009-525629A

### SUMMARY OF INVENTION

In recent years, an earphone is often equipped with a noise cancellation technique for making it difficult for a wearer to hear a sound (for example, a noise component) outside the earphone as much as possible. In addition, an earphone equipped with a microphone for collecting an uttered voice of a wearer has also appeared. This is considered to allow a wearer to easily participate in, for example, a remote conference performed at the time of teleworking or the like which is widely used nowadays in a state of wearing an earphone.

However, many earphones still close the ear of the wearer in order to block an external sound as much as possible. For this reason, when the earphone is worn in a form of closing the ear in the above remote conference or the like, a voice (uttered voice) when the wearer utters by himself/herself does not enter from the outside of the ear of the wearer, the uttered voice arriving at the eardrum along the body of the wearer is in a state of being reverberated in the ear of the wearer, and the wearer has an uncomfortable feeling that the voice uttered by himself/herself drones. In addition, when an ambient environment of the wearer is in a state of blowing to some extent of wind (in other words, an environment in which wind noise is likely to be collected), there is a problem that the wearer not only feels uncomfortable due to noise generated by wind entering from an air vent but also hardly listens to a sound from a speaker.

The present disclosure has been made in view of the above situation in the related art, and an object thereof is to improve convenience for a wearer by achieving both easy hearing of sound depending on a usage situation of the wearer and easy hearing in a case where a wind noise is present.

The present disclosure provide an earphone including a housing having a space therein and having a path capable of ventilation from one end side on an external auditory canal side of a wearer to the other end side on an ambient environment side, a valve accommodated in the housing and configured to switch the path between an open state and a close state, a first microphone disposed on the other end side of the housing and configured to collect an external sound on the ambient environment side, a second microphone disposed on the other end side of the housing and configured to collect an uttered voice of the wearer, and a control unit configured to control the open state and the close state. The control unit is configured to switch the path between the open state and the close state in accordance with an operation mode, and maintain or switch the path in or to the close state in a case where it is determined that a sound signal collected by each of the first microphone and the second microphone during the operation mode is a wind noise.

Further, the present disclosure provide an acoustic control method for an earphone which includes a housing having a space therein and having a path capable of ventilation from one end side on an external auditory canal side of a wearer to the other end side on an ambient environment side, and a valve accommodated in the housing and configured to switch the path between an open state and a close state. The acoustic control method includes switching the path between the open state and the close state in accordance with an operation mode, and maintaining or switching the path in or to the close state when it is determined that a sound signal collected in the operation mode by each of a first microphone disposed on the other end side of the housing and configured to collect an external sound on the ambient environment side and a second microphone configured to collect an uttered voice of the wearer is a wind noise.

Furthermore, the present disclosure provide a computer readable storage medium on which a computer program that causes an earphone which includes a housing having a space therein and having a path capable of ventilation from one end side on an external auditory canal side of a wearer to the other end side on an ambient environment side, and a valve accommodated in the housing and configured to switch the path between an open state and a close state to execute the following steps is stored. The steps includes switching the path between the open state and the close state in accordance with an operation mode; and maintaining or switching the path in or to the close state when it is determined that a sound signal collected in the operation mode by each of a first microphone disposed on the other end side of the housing and configured to collect an external sound on the ambient environment side and a second microphone configured to collect an uttered voice of the wearer is a wind noise.

These comprehensive or specific aspects may be implemented by a system, an apparatus, a method, an integrated circuit, a computer program, or a recording medium, or any combination of the system, the apparatus, the method, the integrated circuit, the computer program, and the recording medium.

According to the present disclosure, it is possible to improve the convenience of the wearer by achieving both the ease of listening to a sound depending on a usage situation of the wearer and easy hearing in a case where a wind noise is present.

### BRIEF DESCRIPTION OF DRAWINGS

FIG. 1 is a front view of an earphone;

FIG. 2 is a rear view of the earphone;

FIG. 3 is a sectional view taken along a line A-A when a valve is in a closed state;

FIG. 4 is a sectional view taken along the line A-A when the valve is in an opened state;

FIG. 5 is a block diagram showing a hardware configuration example of an earphone according to the present embodiment;

FIG. 6 is a block diagram showing a hardware configuration example of a smartphone according to the present embodiment;

FIG. 7 is a diagram showing an example of a table defining an opened/closed state of a valve based on an operation of the earphone and presence or absence of detection of a wind noise;

FIG. 8 is a diagram showing a setting screen example for whether it is necessary to automatically close the valve when a wind noise is detected;

FIG. 9 is a flowchart showing an example of an operation procedure of the earphone according to the present embodiment in time series;

FIG. 10 is a flowchart showing a process of determining whether a wind noise is detected in step St7 of FIG. 9 in detail;

FIG. 11 is a diagram showing an example of a first correspondence table showing a relation example between operation modes and operations of the earphone;

FIG. 12 is a diagram showing an example of a second correspondence table showing a relation example between operation modes and operations of the earphone; and

FIG. 13 is a diagram showing an example of a third correspondence table showing a relation example between operation modes and operations of the earphone.

### DESCRIPTION OF EMBODIMENTS

An embodiment specifically disclosing an earphone, an acoustic control method, and a program according to the present disclosure will be described in detail below with reference to the drawings as appropriate. However, unnecessarily detailed description may be omitted. For example, detailed descriptions of well-known matters and redundant descriptions of substantially the same configuration may be omitted. This is to avoid unnecessary redundancy of the following descriptions and to facilitate understanding of those skilled in the art. The accompanying drawings and the following descriptions are provided for those skilled in the art to fully understand the present disclosure, and are not intended to limit the subject matter described in the claims.

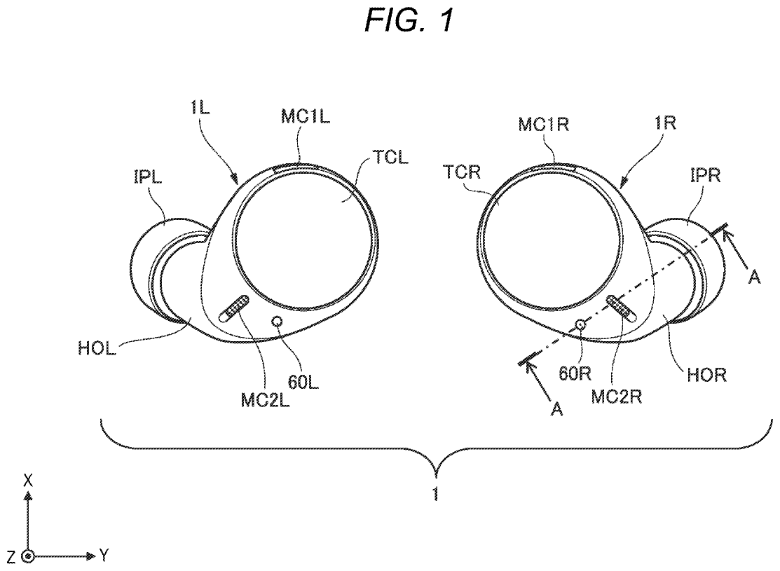

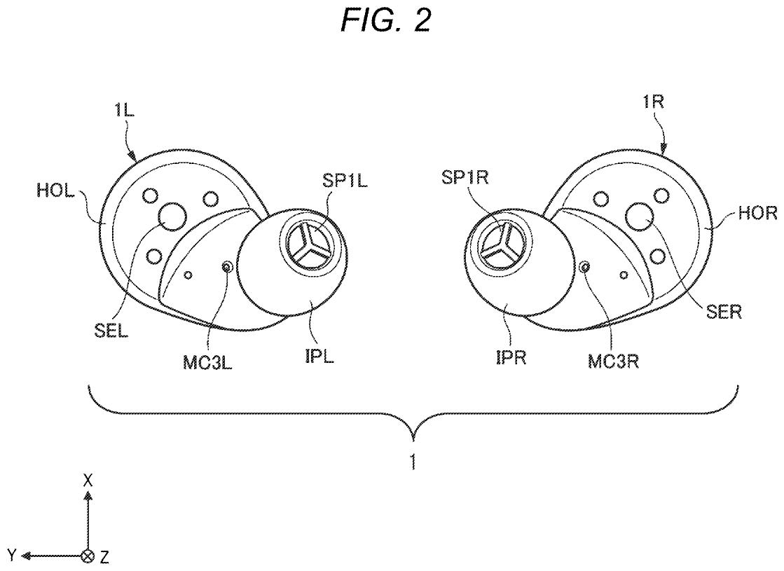

First, a hardware configuration example of an earphone will be described with reference to FIGS. 1 and 2. FIG. 1 is a front view of the earphone. FIG. 2 is a rear view of the earphone. In FIGS. 1 and 2, earphones 1L and 1R are arranged side by side, and an entire surface of each of touch sensors TCL and TCR is arranged to face a front side of a paper surface.

For convenience of explanation, as shown in FIG. 1, an X axis and a Y axis are defined along a plane parallel to a surface of the touch sensor TCL of the earphone 1L, and an axis orthogonal to the surface of the touch sensor TCL is defined as a Z axis. In the earphone 1L, when a microphone MC1L side of the touch sensor TCL is defined as an upper end side and a microphone MC2L side opposite to the microphone MC1L side of the touch sensor TCL is defined as a lower end side, a direction from the lower end side toward the upper end side is defined as an X axis. A direction orthogonal to both the Z axis and the X axis is defined as a Y axis. The definitions of the X, Y, and Z axes can be similarly applied to the earphone 1R. In the present embodiment, a direction of the earphone 1L in FIG. 1 is defined as a front view. The expressions related to these directions are used for convenience of explanation, and are not intended to limit a posture of the structure in actual use. The same applies to other drawings.

In the present embodiment, the earphone 1L for a left ear and the earphone 1R for a right ear of the pair of left and right earphones 1L and 1R have the same configuration. The reference numerals of the same components are expressed with “L” at the end of the earphone 1L for a left ear and with “R” at the end of the earphone 1R for a right ear. In the following description, only the left earphone 1L is described, and the description of the right earphone 1R is not described.

An earphone 1 includes the earphones 1L and 1R which are worn on a left ear and a right ear of a user, respectively, and in which a plurality of earpieces having different sizes are interchangeably worn on one end sides of the respective earphones. Specifically, the earphone 1 may include two independently operable earphones (that is, the earphone 1L and the earphone 1R) of the earphone 1L worn on the left ear of the user and the earphone 1R worn on the right ear of the user. In this case, the earphone 1L and the earphone 1R can communicate with each other wirelessly (for example, short-range wireless communication such as Bluetooth (registered trademark)). The earphone 1 may include a pair of earphones in which the earphone 1L and the earphone 1R are connected by wire (in other words, a cable such as a wire).

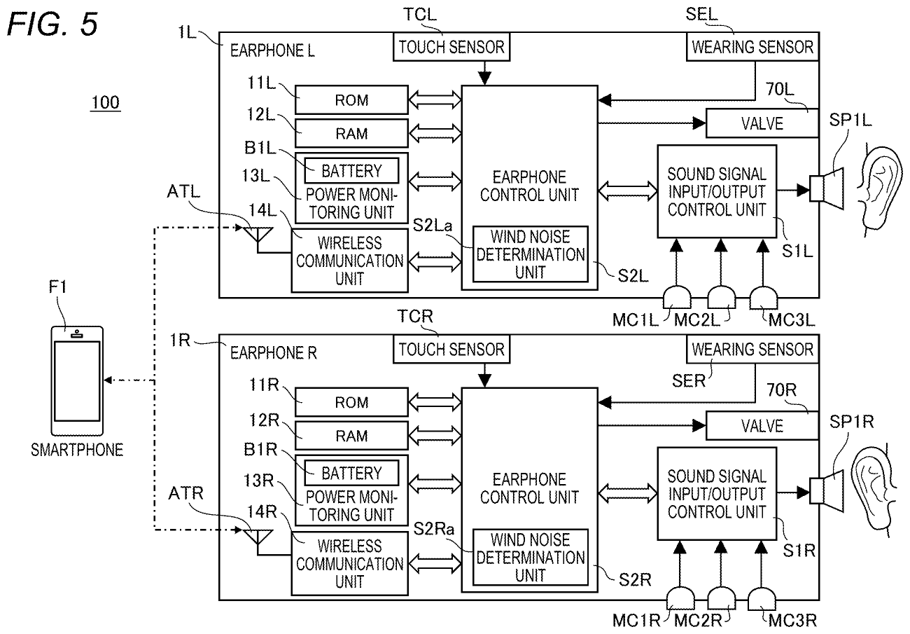

As shown in FIG. 1, the earphone 1L is an inner-type acoustic device used by being worn on the ear of the user, and receives sound data (for example, music data) transmitted wirelessly (for example, short-range wireless communication such as Bluetooth (registered trademark)) from an external device such as a smartphone or a portable music player carried by the user. The earphone 1L acoustically outputs a sound signal based on the received sound data. When not in use, the earphone 1L is placed on a cradle (not shown) which is a charging case. When the earphone 1L is placed at a predetermined placement position of the cradle in a case where a battery B1L (see FIG. 5) incorporated in the earphone 1L is not fully charged, the battery B1L incorporated in the earphone 1L is charged based on electric power transmitted from the cradle.

The earphone 1L includes a housing HOL as a structural member thereof. The housing HOL is made of a composite of materials such as synthetic resin, metal, and ceramic, and an accommodation space that accommodates various members constituting the earphone 1L is formed therein. The housing HOL is provided with an attachment cylindrical portion (not shown) communicating with the accommodation space. The attachment cylindrical portion is provided on one end side of the housing HOL opposite to the touch sensor TCL to be described later.

The earphone 1L includes an earpiece IPL attached to a main body of the earphone 1L. For example, the earphone 1L is held in a state of being inserted into an external auditory canal through the earpiece IPL with respect to the left ear of the user, and this held state is a used state of the earphone 1L.

The earpiece IPL is made of a flexible member such as silicon, and is injection-molded with an inner tubular portion (not shown) and an outer tubular portion (not shown). The earpiece IPL is fixed by being inserted into the attachment cylindrical portion of the housing HOL at the inner tubular portion thereof, and is provided to be replaceable (detachable) with respect to the attachment cylindrical portion of the housing HOL. The earpiece IPL is worn in the external auditory canal of the user at the outer tubular portion thereof, and is elastically deformed depending on a shape of the external auditory canal to be worn. By this elastic deformation, the earpiece IPL is held in the external auditory canal of the left ear of the user. The earpiece IPL has a plurality of different sizes. The earpiece IPL is worn on the left ear of the user by attaching an earpiece having any size among earpieces having a plurality of sizes to the earphone 1L.

As an example of an operation input unit, the touch sensor TCL is provided on the other end side of the housing HOL opposite to one end side where the earpiece IPL is arranged as shown in FIG. 1. The touch sensor TCL is a sensor element having a touch sensor function of detecting an input operation by a user (for example, a touch operation). The sensor element is, for example, an electrode of a capacitive touch sensor. The touch sensor TCL may be formed as, for example, a circular surface or an elliptical surface. In addition, the touch sensor TCL may be formed as a rectangular surface.

As the touch operation on the touch sensor TCL by a finger of the user or the like, for example, the following operation is exemplified. When the touch operation is performed for a short period of time, the earphone 1L may instruct the external device to perform reproduction, stop, tracking, or returning of music. When the touch operation is performed for a long time (so-called long press touch), the earphone 1L may perform a pairing operation or the like for performing wireless communication such as Bluetooth (registered trademark) with an external device such as a smartphone. When the surface of the touch sensor TCL is traced with a finger (so-called “swiping operation”), the earphone 1L may perform volume adjustment or the like on reproduced music.

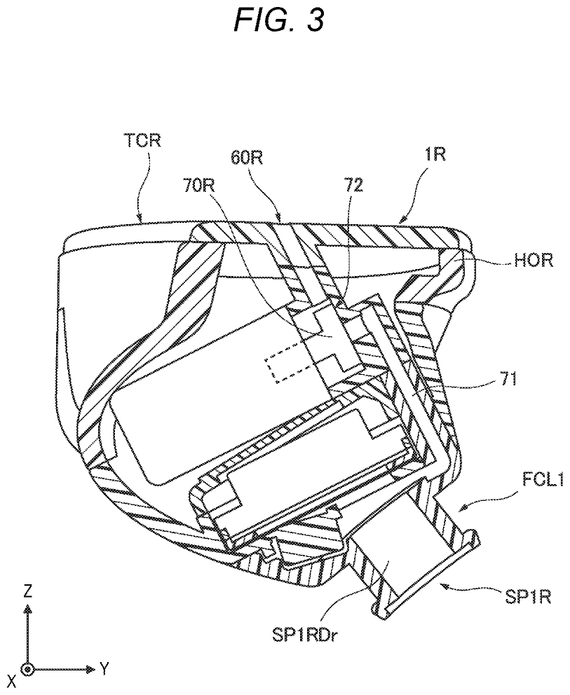

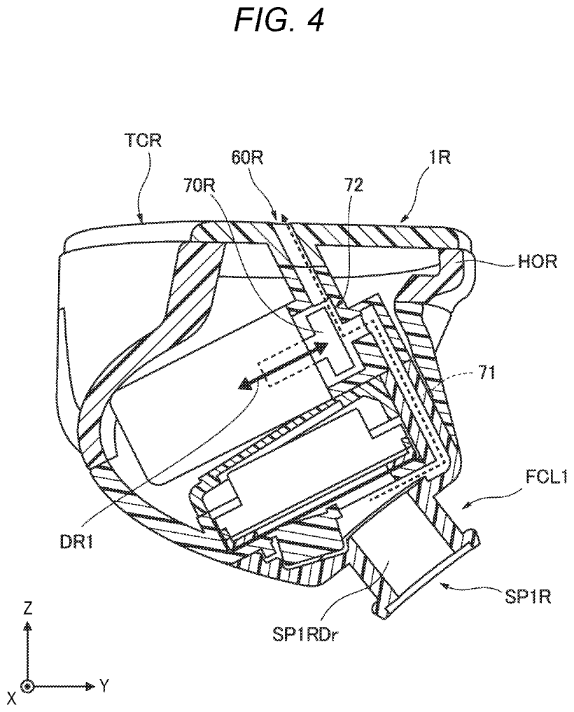

An opening 60L is a hole that is formed to be exposed on the surface of the housing HOL, and leads to a path capable of ventilation from one end side on an external auditory canal side of the user to the other end side on an outside air side (ambient environment side) when being inserted and held in the external auditory canal of the left ear of the user. A cross section example of a detailed structure of the opening 60L will be described later with reference to FIGS. 3 and 4.

The earphone 1L includes a plurality of microphones (microphone MC1L, microphone MC2L, and microphone MC3L) as electric and electronic members. The plurality of microphones are accommodated in the accommodation space (not shown) of the housing HOL.

As shown in FIG. 1, the microphone MC1L is provided so as to be exposed on the surface of the housing HOL or in the vicinity of the surface of the housing HOL, and is disposed to collect an ambient sound (example of external sound) or the like outside the earphone 1L. That is, the microphone MC1L can detect an ambient sound of the user in a state where the earphone 1L is worn on the ear of the user. The microphone MC1L converts the external ambient sound into an electric signal (sound signal) and sends the electric signal to a sound signal input/output control unit S1L.

As shown in FIG. 1, the microphone MC2L is provided so as to be exposed on the surface of the housing HOL or in the vicinity of the surface of the housing HOL, and is disposed to collect a voice signal based on an utterance of a user wearing the earphone 1L. Therefore, the earphone 1L can implement a so-called hands-free call in a state of being capable of communicating with a mobile phone device such as a smartphone F1 of the user. The microphone MC2L is a microphone device capable of collecting (that is, detecting a voice signal) a voice generated based on the utterance of the user. The microphone MC2L collects the voice generated based on the utterance of the user, converts the voice into an electric signal, and sends the electric signal to the sound signal input/output control unit S1L. The microphone MC2L is disposed such that an extending direction of the earphone 1L faces the mouth of the user when the earphone 1L is inserted into the left ear of the user (see FIG. 1), and is disposed at a position of a lower portion of the touch sensor TCL (that is, in the −X direction). The voice uttered by the user is collected by the microphone MC2L and is converted into an electric signal, and presence or absence of the utterance of the user by the microphone MC2L can be detected by a magnitude of the electric signal.

As shown in FIG. 2, the microphone MC3L is disposed in a plane near the attachment cylindrical portion of the housing HOL, and is disposed as close as possible to the external auditory canal of the left ear when the earphone 1L is inserted into the left ear of the user. The microphone MC3L converts a sound leaked from between the left ear of the user and the earpiece IPL in a state where the earphone 1L is worn on the left ear of the user into an electric signal (sound signal) and sends the electric signal to the sound signal input/output control unit S1L.

As shown in FIG. 2, a speaker SP1L is disposed in the attachment cylindrical portion of the housing HOL. The speaker SP1L is an electronic component including a driver SP1LDr (see FIGS. 3 and 4), and acoustically outputs sound data (for example, music data) wirelessly transmitted from an external device. Inside the housing HOL, a front surface (in other words, a sound releasing surface of the sound to be acoustically output) of the speaker SP1 is directed toward an attachment cylindrical portion side of the housing HOL covered with the earpiece IPL. Accordingly, the music data acoustically output from the speaker SP1L is transmitted from an ear hole (for example, an external ear) of the user to the external auditory canal of the external ear and an eardrum of a middle ear, and the user can listen to the music data.

A wearing sensor SEL is implemented by a device that detects presence or absence of wearing on the left ear of the user, and is implemented by using, for example, an infrared sensor or an electrostatic sensor. In the case of an infrared sensor, when the earphone 1L is worn on the left ear of the user, the wearing sensor SEL can detect that wearing on the left ear of the user by receiving an infrared light obtained by reflecting an infrared light emitted from the wearing sensor SEL in the left ear. When the earphone 1L is not worn on the left ear of the user, the wearing sensor SEL can detect wearing on the left ear of the user by not reflecting an infrared light emitted from the wearing sensor SEL and not receiving the infrared light. On the other hand, in the case of an electrostatic sensor, when the earphone 1L is worn on the left ear of the user, the wearing sensor SEL can detect wearing on the left ear of the user by determining that a change value of an electrostatic capacitance corresponding to a distance to the inside of the left ear of the user is larger than a threshold held by the wearing sensor SEL. When the earphone 1L is not worn on the left ear of the user, the wearing sensor SEL can detect non-wearing on the left ear of the user by determining that the change value of the electrostatic capacitance value is smaller than the threshold held by the wearing sensor SEL. The wearing sensor SEL is provided at a position facing the external auditory canal and on a back surface side of the touch sensor TCL when the earphone 1L is inserted into the left ear of the user.

In this way, in the earphone 1L, an earpiece being worn, which is an earpiece having any size among the plurality of earpieces having different sizes, is worn on the left ear or the right ear of the user.

Next, an opened state and a closed state of a valve will be described with reference to FIGS. 3 and 4. FIG. 3 is a sectional view taken along a line A-A when the valve is in the closed state. FIG. 4 is a sectional view taken along the line A-A when the valve is in the opened state. For convenience of explanation, FIGS. 3 and 4 show the earphone 1R, but as described above, the earphones 1L and 1R have the same structure, and the same description can be applied to the earphone 1L. In the following description, the opened state may be referred to as an open state, and the closed state may be referred to as a close state.

The sectional view shown in FIG. 3 is a sectional view taken along the line A-A of the earphone 1R in FIG. 1. A valve 70R is a device including a movable mechanism that controls air passing through the path 71. The valve 70R switches the path 71 for releasing the sound remaining in the housing HOR to the outside of the housing HOR between the open state and the close state. The sound remaining in the housing HOR is, for example, an echo sound of a sound output from the driver SP1RDr constituting the speaker SP1R, or a transmission sound that is acoustically transmitted to the vicinity of the right ear via the body of the user himself/herself by the utterance of the user. The sound causes an uncomfortable feeling or difficulty in listening to an external sound when the user utters in a state of wearing the earphone 1R. An operation (specifically, opening and closing) of the valve 70R is controlled by an earphone control unit S2R. The valve may be, for example, a gate valve shown in FIG. 3, and may be a globe valve, a needle valve, a ball valve, or a butterfly valve.

The valve 70R can be brought into the close state by blocking the path 71 by moving back and forth along a direction DR1 (see FIG. 4) and abutting against a wall surface 72. A state shown in FIG. 3 in which the valve 70 abuts against the wall surface 72 and blocks a part of the path 71 is referred to as a “closed state” or a “close state”. When the user wears the earphone 1R on the right ear and the valve 70 is in the closed state (close state), the path 71 is blocked by the valve 70R, and the ear of the user is blocked from the ambient environment (outside air) and closed.

A state shown in FIG. 4 in which the valve 70R is separated from the wall surface 72 by a certain distance to open the path 71 is referred to as an “opened state” or an “open state”. When the user wears the earphone 1R on the right ear and the valve 70R is in the opened state (open state), the path 71 is not blocked by the valve 70R and communicates with the ambient environment (outside air) on a touch sensor TCR side, and thus the ear of the user is not blocked (closed) from the ambient environment (outside air). In this state, the sound remaining in the housing HOR is released to the outside of the housing HOR via the path 71, and it is expected that, when the user utters in a state of wearing the earphone 1R, it is possible to prevent the user from feeling uncomfortable or difficult to hear an external sound.

Next, a hardware configuration example of the earphone will be described with reference to FIG. 5. FIG. 5 is a block diagram showing a hardware configuration example of an earphone according to the present embodiment. Specifically, FIG. 5 is a block diagram showing a hardware configuration example of the pair of left earphone 1L and right earphone 1R shown in FIGS. 1 and 2. Hereinafter, the configuration of the earphone 1L of the pair of left earphone 1L and right earphone 1R will be described, and since the configuration of the earphone 1R is the same as the configuration of the earphone 1L, the description of the configuration of the earphone 1L can be similarly applied to the description of the corresponding components of the earphone 1R except for the difference in reference numerals.

A wireless acoustic system 100 shown in FIG. 5 includes the earphone 1L, the earphone 1R, and the smartphone F1. The earphone 1L includes the touch sensor TCL, the wearing sensor SEL, a read only memory (ROM) 11L, a random access memory (RAM) 12L, a power monitoring unit 13L including the battery B1L, a wireless communication unit 14L, the sound signal input/output control unit S1L, an earphone control unit S2L, a valve 70L, the microphone MC1L, the microphone MC2L, and the microphone MC3L.

The touch sensor TCL as an example of the operation input unit is communicably connected to the earphone control unit S2L. The touch sensor TCL generates a signal related to a touch operation performed by a user who is a wearer, and outputs the signal to the earphone control unit S2L.

The wearing sensor SEL is connected to the earphone control unit S2L so as to enable data input and output, generates a signal relating to whether the left ear of the user is in contact with the earphone 1L, and outputs the signal to the earphone control unit S2L.

The power monitoring unit 13L is implemented using, for example, a semiconductor chip. The power monitoring unit 13L includes the battery B1L and measures a remaining charge capacity of the battery B1L. The battery B1L is a secondary battery such as a lithium ion battery. The power monitoring unit 13L outputs information related to the measured remaining charge capacity of the battery B1L to the earphone control unit S2L.

The wireless communication unit 14L is wirelessly connected to the smartphone F1 so as to enable data communication, and transmits a sound signal processed by the sound signal input/output control unit S1L or the earphone control unit S2L to the smartphone F1. The wireless communication unit 14L includes an antenna ATL and performs short-range wireless communication according to, for example, a Bluetooth (registered trademark) communication standard. The wireless communication unit 14L may be connected to a communication line such as Wi-Fi (registered trademark), a mobile communication line, or the like. The earphones 1L and 1R can individually perform wireless communication with the smartphone F1 using the wireless communication units 14L and 14R, respectively. Therefore, each of the earphones 1L and 1R can receive data, a sound signal, or information transmitted from the smartphone F1.

The sound signal input/output control unit S1L is implemented using a processor such as a central processing unit (CPU), a micro processing unit (MPU), a digital signal processor (DSP), or a field programmable gate array (FPGA). The sound signal input/output control unit S1L is connected to the earphone control unit S2L so as to enable data input and output, and exchanges a sound signal with a digital signal converted into a digital format by a pulse code modulation (PCM) system. The sound signal input/output control unit S1L adjusts a volume level of a digital signal relating to the sound signal acquired from the smartphone F1 and outputs the digital signal to the speaker SP1L.

The sound signal input/output control unit S1L is connected to the microphones MC1L, MC2L, and MC3L, and receives from the microphones, sound signals collected by the microphones. The sound signal input/output control unit S1L may be capable of performing a process such as amplifying the sound signal received from each microphone, and converting an analog signal into a digital signal. The sound signal input/output control unit S1L transmits data of the sound signal received from each microphone to the earphone control unit S2L.

The earphone control unit S2L as an example of the control unit is implemented using a processor such as a CPU, an MPU, a DSP, or an FPGA, is connected to the sound signal input/output control unit S1L, the ROM 11L, the RAM 12L, the power monitoring unit 13L, and the wireless communication unit 14L so as to enable data input and output, and exchanges a sound signal as a signal converted into a digital form. The earphone control unit S2L functions as a controller that controls an overall operation of the earphone 1L, and performs a control process for controlling an overall operation of each unit of the earphone 1L, and a data input/output process, a data arithmetic process, and a data storage process with each unit of the earphone 1L.

The sound signal input/output control unit S1L and the earphone control unit S2L implement respective functions by using a program and control data stored in the ROM 11L. The sound signal input/output control unit S1L and the earphone control unit S2L may use the RAM 12L during operation and temporarily store generated or acquired data or information in the RAM 12L.

The earphone control units S2L and S2R can functionally execute corresponding wind noise determination units S2La and S2Ra. The wind noise determination unit S2La detects presence or absence of a wind noise based on at least one of a sound pressure level and a correlation (similarity) between waveforms of sound signals collected by the microphones MC1L and MC2L. For example, when it is determined that at least one of the sound pressure level and the correlation (similarity) between the sound signals detected by the microphones MC1L and MC2L exceeds respective predetermined thresholds for the sound pressure level and the correlation, the wind noise determination unit S2La determines that the collected sound signals are sound signals for a wind noise. The predetermined thresholds include a threshold of the correlation (similarity) between waveforms of sound signals and a threshold of the sound pressure level. Here, the microphones MC1L and MC2L are disposed outward with respect to the housing HOL, and thus for example, under a situation where a wind noise is generated, both of the microphones MC1L and MC2L can be considered to have the same sound pressure level and waveform of the sound signal of the wind noise. However, the microphone MC2L collects the uttered voice of the wearer in a call, and thus in this case, the wind noise determination unit S2La can determine that a wind noise is detected when it is determined that a waveform of a sound signal excluding a sound signal waveform of a frequency band (for example, 100 Hz to 1 kHz) of the uttered voice is correlated with a waveform of the sound signal collected by the microphone MC1L or/and the sound pressure levels are equivalent.

The valve 70L is connected to the earphone control unit S2L so as to enable data input and output. The valve 70L operates (that is, opens and closes) based on a signal from the earphone control unit S2L. The valve 70L is controlled to be in the opened state (open state) or the closed state (close state) by the earphone control unit S2L based on contents set on a setting screen displayed on the smartphone F1. In the present embodiment, for example, the valve 70L is controlled based on an operation of the earphone 1L or an operation mode (described later) of the earphone 1L. Details of a method for controlling the valve 70L will be described later.

The smartphone F1 is a wireless terminal carried by a user.

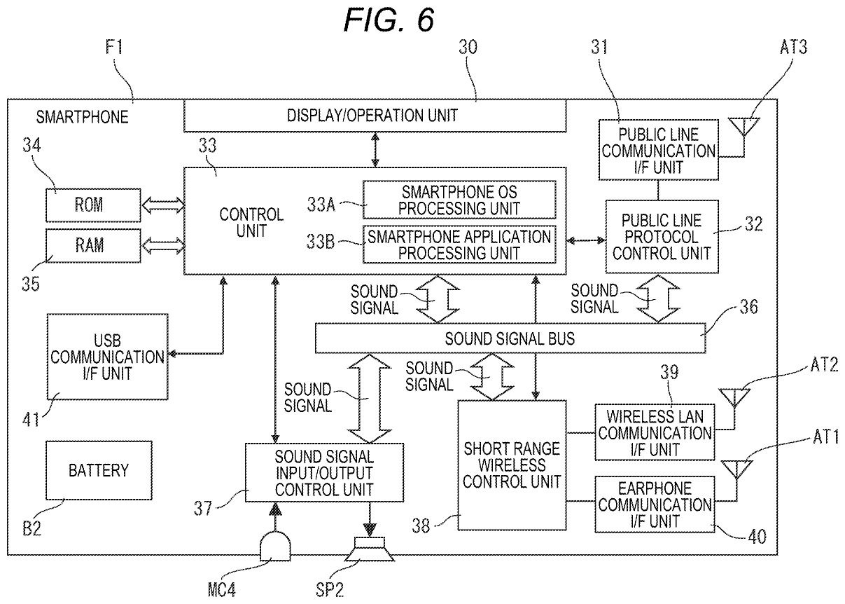

Next, a hardware configuration example of the smartphone will be described with reference to FIG. 6. FIG. 6 is a block diagram showing the hardware configuration example of the smartphone according to the present embodiment. The smartphone F1 includes a display/operation unit 30, a public line communication I/F unit 31, a public line protocol control unit 32, a control unit 33, a ROM 34, a RAM 35, a sound signal bus 36, a sound signal input/output control unit 37, a short-range wireless control unit 38, a wireless LAN communication I/F unit 39, an earphone communication I/F unit 40, a USB communication I/F unit 41, and a battery B2. In FIG. 6, an interface is abbreviated as “I/F”.

The display/operation unit 30 as an example of a display unit or an operation unit is implemented using a touch panel that receives an operation by the user and displays data generated by the control unit 33, and forms a so-called user interface. The display/operation unit 30 may display various screens generated by the control unit 33. The display/operation unit 30 receives an operation by the user on the displayed various screens, generates an input signal, and sends the input signal to the control unit 33.

The public line communication I/F unit 31 is connected to an antenna AT3 included in the smartphone F1 and performs wireless communication (for example, wireless communication conforming to a fourth generation mobile communication system (4G) or a fifth generation mobile communication system (5G) such as a long term evolution (LTE)) with a public base station (not shown) using a public line. The public line communication I/F unit may be omitted from the configuration of the smartphone F1.

The public line protocol control unit 32 executes control relating to data input and output between the sound signal bus 36 and the public line communication I/F unit 31. The public line protocol control unit 32 may be omitted from the configuration of the smartphone F1.

The control unit 33 is implemented using a processor such as a CPU, an MPU, or a DSP. A smartphone OS processing unit 33A and a smartphone application processing unit 33B are functionally included, and the smartphone OS processing unit 33A and the smartphone application processing unit 33B perform various processes and controls in cooperation with the ROM 34.

A program that defines an operation of the control unit 33 and data used during execution of the program are written in the ROM 34. The ROM 34 stores identification information of the smartphone F1 and identification information of the earphone 1 registered in advance as a destination to which a sound signal is transmitted.

The RAM 35 is a RAM as a work memory used when each process of the control unit 33 is executed, and the RAM 35 temporarily stores data or information generated or acquired by the control unit 33.

The sound signal bus 36 inputs and outputs sound signal data to and from the control unit 33, sound signal data to and from the public line protocol control unit 32, sound signal data to and from the sound signal input/output control unit 37, and sound signal data to and from the short-range wireless control unit 38.

The sound signal input/output control unit 37 transmits the sound signal data collected by a microphone MC4 to the control unit 33 via the sound signal bus 36 and outputs the sound signal received via the sound signal bus 36 from a speaker SP2 based on a command output from the control unit 33.

The microphone MC4 collects a voice based on an utterance of a user using the smartphone F1, converts the voice into a sound signal, and transmits the converted sound signal to the sound signal input/output control unit 37. The sound signal collected by the microphone MC4 is input to the control unit 33 via the sound signal input/output control unit 37 and the sound signal bus 36.

The speaker SP2 acoustically outputs the sound signal data from the sound signal input/output control unit 37.

The short-range wireless control unit 38 executes control related to data input and output between the sound signal bus 36 and the wireless LAN communication I/F unit 39 as well as between the sound signal bus 36 and the earphone communication I/F unit 40. The short-range wireless control unit 38 transmits the command output from the control unit 33 and data of a sound signal received via the sound signal bus 36 to the wireless LAN communication I/F unit 39 or the earphone communication I/F unit 40. The short-range wireless control unit 38 may transmit data of a sound signal received from the wireless LAN communication I/F unit 39 or the earphone communication I/F unit 40 to the control unit 33.

The wireless LAN communication I/F unit 39 is connected to an antenna AT2 included in the smartphone F1 and performs wireless communication (for example, data transmission from the short-range wireless control unit 38) with the earphone 1 using a wireless LAN. The wireless LAN communication I/F unit 39 is implemented using a communication circuit that can be connected to the Internet via a wireless LAN router (not shown). The wireless LAN communication I/F unit 39 may perform wireless communication (for example, wireless LAN such as Wi-Fi (registered trademark)) with the earphones 1L and 1R via the above wireless LAN router (not shown).

The earphone communication I/F unit 40 is connected to an antenna AT1 included in the smartphone F1, and performs short-range wireless communication (for example, data transmission from the short-range wireless control unit 38) with the earphone 1 according to Bluetooth.

The USB communication I/F unit 41 is an interface for communicating with the smartphone F1 and an external device (for example, a personal computer (PC)) via a cable or the like. The USB communication I/F unit 41 is connected to the control unit 33 to enable data communication, and can transmit data from the external device to the control unit 33. The USB communication I/F unit 41 may supply electric charge from an external commercial power supply to the battery B2.

The battery B2 is a secondary battery (for example, a lithium ion battery) capable of accumulating the electric charge supplied from the external commercial power supply, and supplies necessary power to each unit of the smartphone F1. The battery B2 may be implemented to be detachable from a housing of the smartphone F1. The battery B2 may directly supply power from the external commercial power supply, and may supply power to the smartphone F1 in a state of being disconnected from the external commercial power supply.

Next, an operation example for controlling opening and closing of a valve according to the operations of the earphones 1L and 1R and presence or absence of detection of a wind noise will be described.

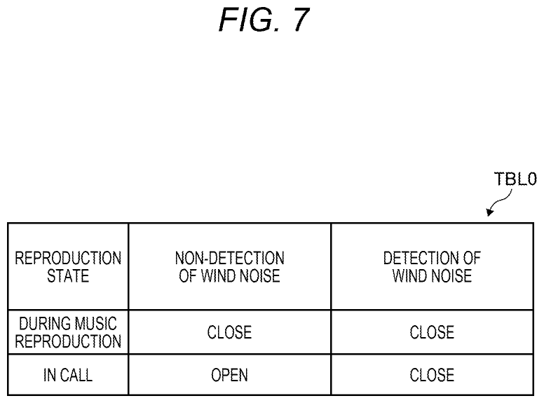

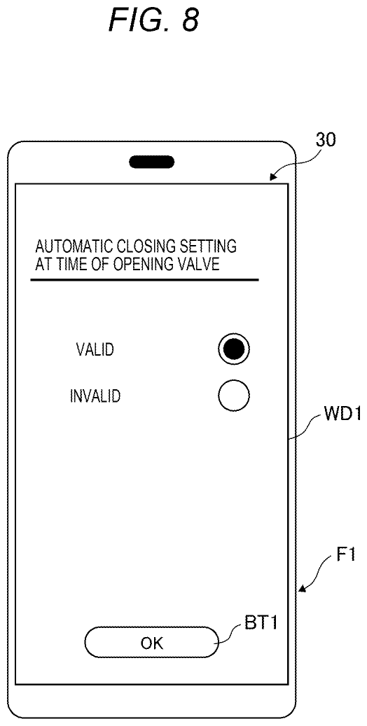

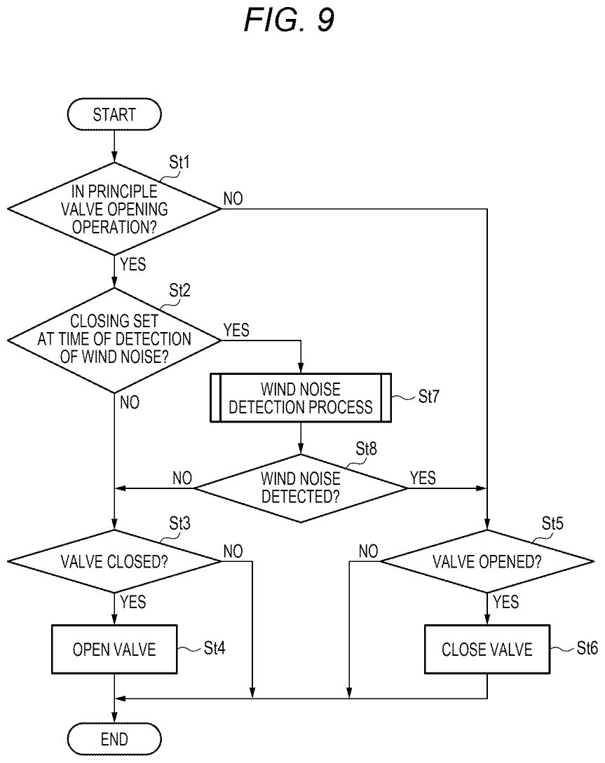

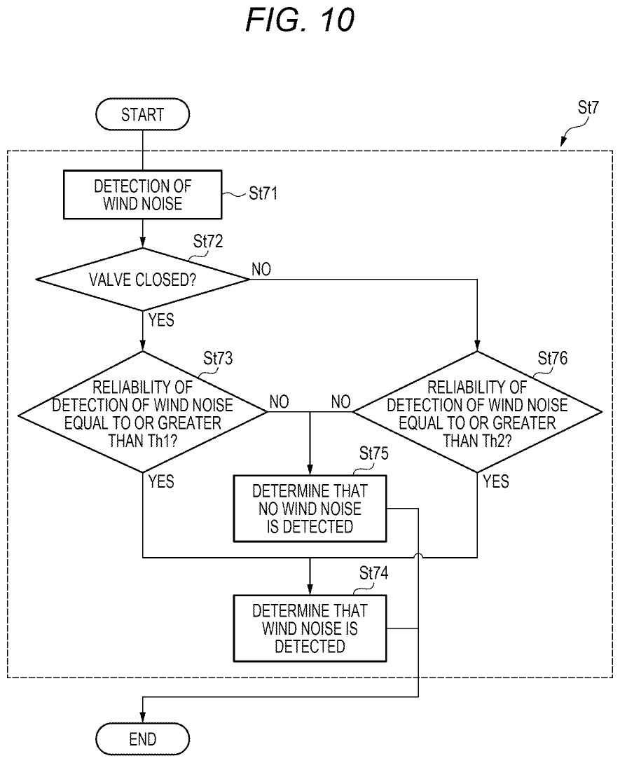

FIG. 7 is a diagram showing an example of a table defining the opened state and the closed state of the valve based on operations of the earphone and presence or absence of detection of a wind noise. FIG. 8 is a diagram showing a setting screen example for setting whether it is necessary to automatically close the valve when a wind noise is detected. FIG. 9 is a flowchart showing an example of an operation procedure of the earphone according to the present embodiment in time series. FIG. 10 is a flowchart showing a process of determining whether a wind noise is detected in step St7 of FIG. 9 in detail. The flowchart in FIG. 9 is periodically executed by the earphone control units S2L and S2R of the respective earphones 1L and 1R.

A table TBL0 shown in FIG. 7 defines states of the valves 70L and 70R according to reproduction states of the earphones 1L and 1R (specifically, during music reproduction or in a call) and presence or absence of detection of a wind noise. The states of the valves 70L and 70R are an open state (OPEN) and a close state (CLOSE).

When the user is in a call (in other words, while the microphones MC2L and MC2R are collecting the uttered voice of the user), the earphone control units S2L and S2R maintain or switch the respective valves 70L and 70R in or to the open state if no wind noise is detected by the respective wind noise determination units S2La and S2Ra. Accordingly, when the user is in a call and no wind noise is detected, both of the valves 70L and 70R are maintained in the open state, and thus the paths 71 in the respective housings HOL and HOR communicate with the outside air, whereby a user is prevented from feeling that the voice uttered by himself/herself is muffled even while the earphones 1L and 1R are being worn.

When the user is in a call (in other words, while the microphones MC2L and MC2R are collecting the uttered voice of the user), the earphone control units S2L and S2R switches the respective valves 70L and 70R from the open state to the close state when a wind noise is detected by the respective wind noise determination units S2La and S2Ra. Accordingly, since the earphones 1L and 1R bring the respective valves 70L and 70R into the close state when a wind noise is detected during the call of the user, it is possible to prevent the user from feeling uncomfortable due to the influence of a wind noise.

On the other hand, while the user is reproducing music (that is, when music signals are acoustically output from the speakers SP1L and SP1R), the earphone control units S2L and S2R maintain or switch the respective valves 70L and 70R in or to the close state regardless of whether a wind noise is detected. Accordingly, for example, when a user wants to listen to music in a concentrated manner, the valves 70L and 70R are in the close state regardless of the presence or absence of a wind noise, whereby deterioration of a sound quality of music can be further prevented, and the user can comfortably enjoy music listening.

A setting screen WD1 shown in FIG. 8 is displayed on the display/operation unit 30 among dedicated applications installed in the smartphone F1, for example, by a user operation. It is possible to set on the setting screen whether to automatically close the valves 70L and 70R (that is, close state) when a wind noise is detected by the respective earphones 1L and 1R. The setting screen WD1 displays a valid icon and an invalid icon. The valid icon and the invalid icon can be alternatively selected by a user operation. In FIG. 8, for example, a valid icon is designated. When an OK icon BT1 is pressed by the user operation after the designation, the smartphone F1 shares, with the earphones 1L and 1R, open/close setting of the valves 70L and 70R associated with detection of a wind noise corresponding to the pressing of the OK icon BT1. Accordingly, the earphones 1L and 1R can automatically control the respective valves 70L and 70R to the close state based on detection of a wind noise.

In FIG. 9, the earphone control units S2L and S2R of the respective earphones 1L and 1R refer to, for example, the respective RAMs 12L and 12R to determine whether a current operation mode of the respective earphones 1L and 1R is a principle valve opening operation (step St1). Here, in principle, the principle valve opening operation indicates the operation of the earphones 1L and 1R in which it is desirable to bring the valves 70L and 70R into an open state, and corresponds to, for example, a case where the user is in a call. The principle valve opening operation is not limited to in a call. Although this is described as principle, in the present embodiment, each of the valves 70L and 70R is in the open state during the principle valve opening operation in principle, and when a wind noise is detected as an exceptional process, the valves 70L and 70R are switched to the close state.

When it is determined that the current operation mode of each of the earphones 1L and 1R is in the principle valve opening operation (YES in step St1), the earphone control units S2L and S2R refer to, for example, the respective RAMs 12L and 12R to determine whether automatic closing (close state) of the respective valves 70L and 70R is set at the time of detection of a wind noise (step St2). When it is determined that automatic closing (close state) of the valves 70L and 70R is not set at the time of detection of a wind noise (NO in step St2), the earphone control units S2L and S2R refer to, for example, the respective RAMs 12L and 12R to determine whether the respective valves 70L and 70R are in the closed state (close state) (step St3).

When it is determined that the valves 70L and 70R are not in the closed state (close state) (NO in step St3), the process on the earphone control units S2L and S2R in FIG. 9 ends. On the other hand, when it is determined that the valves 70L and 70R are in the closed state (close state) (YES in step St3), the earphone control units S2L and S2R bring the respective valves 70L and 70R to the open state to open the respective paths 71 so as to communicate with the outside air (step St4). Accordingly, when a wind noise is not detected at present and the operation mode is in the principle valve opening operation, each of the valves 70L and 70R is in the open state, and thus the user can be prevented from feeling uncomfortable that the voice uttered by himself/herself is muffled and can comfortably make a call in the principle valve opening operation (for example, in a call).

On the other hand, when it is determined that the current operation mode of each of the earphones 1L and 1R is not the principle valve opening operation (NO in step St1), the earphone control units S2L and S2R refer to, for example, the respective RAMs 12L and 12R to determine whether the respective valves 70L and 70R are in the opened state (open state) (step St5).

When it is determined that the valves 70L and 70R are not in the opened state (open state) (NO in step St5), the process on the earphone control units S2L and S2R in FIG. 9 ends. On the other hand, when it is determined that the valves 70L and 70R are in the opened state (open state) (YES in step St5), the earphone control units S2L and S2R bring the respective valves 70L and 70R to the close state to block the respective paths 71 from the outside air (step St6). Accordingly, in a case where the operation mode is not the principle valve opening operation (for example, in a case where the user is listening to music), such as a case where a wind noise is detected at present, each of the valves 70L and 70R is in the close state, and thus the user can concentrate on the music without paying attention to an ambient external sound.

When it is determined that automatic closing (close state) of the valves 70L and 70R are set at the time of detection of a wind noise (YES in step St2), the earphone control units S2L and S2R determine presence or absence of detection of a wind noise based on sound signals collected by two types of microphones (for example, the microphones MC1L and MC2L of the earphone 1L and the microphones MC1R and MC2R of the earphone 1R) (step St7). Details of step St7 will be described later with reference to FIG. 10.

When it is determined that a wind noise is detected (YES in step St8), the earphone control units S2L and S2R refer to, for example, the respective RAMs 12L and 12R to determine whether the respective valves 70L and 70R are in the opened state (open state) (step St5). Since the processes of steps St5 and St6 are as described above, the description thereof will be omitted.

When it is determined that no wind noise is detected (NO in step St8), the earphone control units S2L and S2R refer to, for example, the respective RAMs 12L and 12R to determine whether the respective valves 70L and 70R are in the closed state (close state) (step St3). Since the processes of steps St3 and St4 are as described above, the description thereof will be omitted.

In FIG. 10, the earphone control units S2L and S2R detect the presence or absence of a wind noise based on at least one of the sound pressure level and the correlation (similarity) between sound signals collected by the microphones MC1L and MC2L of the earphone 1L and the microphones MC1R and MC2R of the earphone 1R (step St71). In step St71, the earphone control unit S2L calculates the reliability based on the sound pressure level and the correlation (similarity) between sound signals collected by the respective microphones MC1L and MC2L. For example, if the correlation and the sound pressure level are both similar to each other, the reliability is high, and on the other hand, if the correlation and the sound pressure level are both different from each other, the reliability is low. When it is determined that the calculated reliability exceeds a predetermined reliability threshold, the earphone control units S2L and S2R determine that a wind noise is detected.

The earphone control units S2L and S2R refer to, for example, the respective RAMs 12L and 12R to determine whether the respective valves 70L and 70R are in the closed state (close state) (step St72). When it is determined that the valves 70L and 70R are in the closed state (close state) (YES in step St72), the earphone control units S2L and S2R determine whether the reliability relating to the detection of a wind noise calculated in step St71 is equal to or greater than a predetermined value Th1 (step St73). When it is determined that the reliability related to the detection of a wind noise is equal to or greater than the predetermined value Th1 (YES in step St73), the earphone control units S2L and S2R determine that a wind noise is detected (step St74). Thereafter, the process of determining the presence or absence of a wind noise shown in FIG. 10 ends.

On the other hand, when it is determined that the reliability relating to the detection of a wind noise is less than the predetermined value Th1 (NO in step St73), the earphone control units S2L and S2R determine that no wind noise is detected (step St75). Thereafter, the process of determining the presence or absence of a wind noise shown in FIG. 10 ends.

When it is determined that the valves 70L and 70R are not in the closed state (close state) (NO in step St72), the earphone control units S2L and S2R determine whether the reliability relating to the detection of a wind noise calculated in step St71 is equal to or greater than a predetermined value Th2 (step St76). Here, the predetermined value Th1 and the predetermined value Th2 may be the same value or different values. The predetermined value Th1 is a reliability threshold when the valves 70L and 70R are in the close state. The predetermined value Th2 is a reliability threshold when the valves 70L and 70R are in the open state.

When it is determined that the reliability related to the detection of a wind noise is equal to or greater than the predetermined value Th2 (YES in step St76), the earphone control units S2L and S2R determine that a wind noise is detected (step St74). Thereafter, the process of determining the presence or absence of a wind noise shown in FIG. 10 ends.

On the other hand, when it is determined that the reliability relating to the detection of a wind noise is less than the predetermined value Th2 (NO in step St76), the earphone control units S2L and S2R determine that no wind noise is detected (step St75). Thereafter, the process of determining the presence or absence of a wind noise shown in FIG. 10 ends.

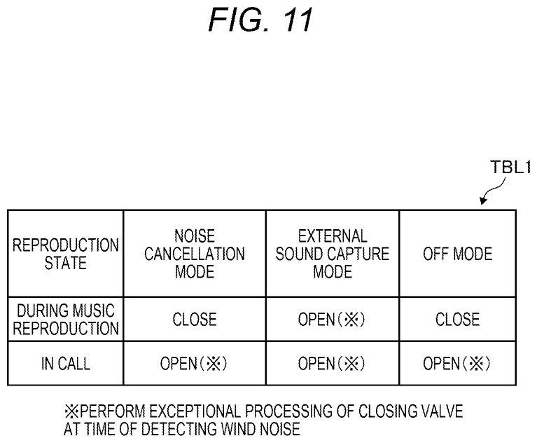

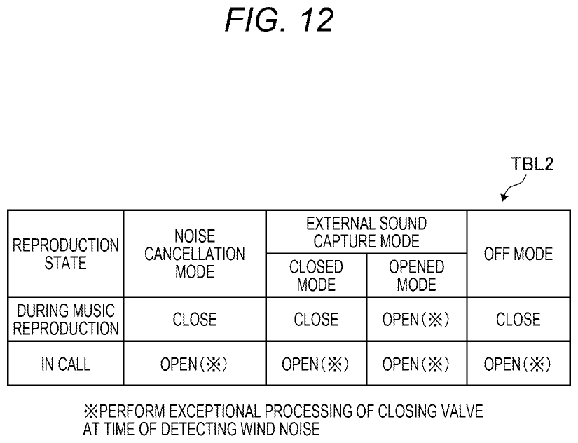

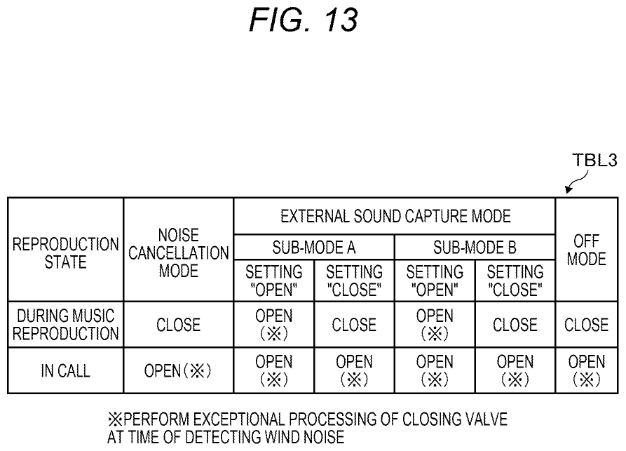

FIG. 11 is a diagram showing an example of a first correspondence table showing a relation example between operation modes and operations of the earphone. FIG. 12 is a diagram showing an example of a second correspondence table showing a relation example between operation modes and operations of the earphone. FIG. 13 is a diagram showing an example of a third correspondence table showing a relation example between operation modes and operations of the earphone.

The operation modes of the earphone according to the present embodiment include, for example, a noise cancellation mode, an external sound capture mode, and an OFF mode.

The noise cancellation mode is an operation mode for executing a known noise cancellation process. In the noise cancellation process, for example, an opposite phase signal of an ambient noise component is generated using a sound signal collected by each of the earphone 1L (specifically, the microphones MC1L and MC3L) and the earphone 1R (specifically, the microphones MC1R and MC3R), and the opposite phase signal is synthesized with a sound signal as a target to be acoustically output, whereby the ambient noise component can be further prevented or removed.

The external sound capture mode is an operation mode in which ambient external sounds of the earphones 1L and 1R are actively collected and captured. In the external sound capture mode, sound signals of external sounds collected by the microphone MC1L of the earphone 1L and the microphone MC1R of the earphone 1R are input to the earphone control units S2L and S2R, respectively.

The OFF mode is a so-called normal operation mode, and neither a noise cancellation process nor an external sound capture process is performed.

The noise cancellation mode, the external sound capture mode, and the OFF mode can be easily switched to one another by a predetermined user operation. The predetermined user operation may be, for example, a long press operation for the touch sensors TCL and TCR of the respective earphones 1L and 1R, or an operation for designating an operation mode from a dedicated application (not shown) installed in the smartphone F1. Accordingly, the operation modes of the earphones 1L and 1R can be changed by a simple operation of the user.

A correspondence table TBL1 shown in FIG. 11 defines states of the valves 70L and 70R in accordance with reproduction states (specifically, during music reproduction or in a call) and the operation modes (specifically, the noise cancellation mode, the external sound capture mode, and the OFF mode) of the respective earphones 1L and 1R. The states of the valves 70L and 70R are the open state and the close state.

When the user is in a call (in other words, while the microphones MC2L and MC2R are collecting the uttered voice of the user), the earphone control units S2L and S2R switch the respective valves 70L and 70R to the open state regardless of the operation mode. That is, the valves 70L and 70R are maintained in the open state in the noise cancellation mode, the external sound capture mode, or the OFF mode. Accordingly, when the user is in a call, both the valves 70L and 70R are maintained in the open state, and thus the paths 71 in the housings HOL and HOR communicate with the outside air, whereby a user is prevented from feeling that the voice uttered by himself/herself is muffled even while the earphones 1L and 1R are being worn.

However, when a wind noise is detected in a case where the user is in a call and the valves 70L and 70R are in the open state, the earphones 1L and 1R switch the respective valves 70L and 70R to the close state regardless of the type of the operation mode shown in FIG. 11.

On the other hand, while the user is reproducing music (that is, when music signals are acoustically output from the speakers SP1L and SP1R), the earphone control units S2L and S2R switch the respective valves 70L and 70R to the close state if the operation mode is the noise cancellation mode or the OFF mode. When the operation mode is the external sound capture mode, the earphone control units S2L and S2R switch the respective valves 70L and 70R to the open state. Accordingly, for example, when the user wants to listen to music in a concentrated manner, the user can switch the mode to the noise cancellation mode or the OFF mode to bring the valves 70L and 70R into the close state, whereby deterioration of a sound quality of music can be prevented and the user can comfortably enjoy music listening. In addition, even when the user is not in a call (for example, during music reproduction), the user can listen to the ambient external sound by switching the mode to the external sound capture mode to bring the valves 70L and 70R into the open state, thereby improving convenience.

However, when a wind noise is detected in a case where the valves 70L and 70R are in the open state because the user is reproducing music and the operation mode is the external sound capture mode, the earphones 1L and 1R switch the respective valves 70L and 70R to the close state.

The external sound capture mode in FIG. 12 includes two sub-modes of a closed mode and an opened mode. The opened mode of the external sound capture mode is an operation mode in which external sounds around the earphones 1L and 1R are actively collected and captured. The opened mode is used, for example, when it is desired to actively listen to the utterance of another person uttering around. On the other hand, the closed mode of the external sound capture mode is used when it is not required to actively capture the ambient external sound but capturing an ambient external sound intends to assist the operation of the user. For example, in a case where the user is not in a call and wants to listen to an ambient external sound such as a case where the user is walking or wants to listen to an announcement of a phone, it is expected that the sound quality of music that is acoustically output from the earphones 1L and 1R is improved by setting the closed mode.

A correspondence table TBL2 shown in FIG. 12 defines the states of the valves 70L and 70R corresponding to the reproduction states (specifically, during music reproduction or in a call) and the operation modes (specifically, the noise cancellation mode, the closed mode of the external sound capture mode, the opened mode of the external sound capture mode, and the OFF mode) of the earphones 1L and 1R. The states of the valves 70L and 70R are the open state and the close state.

When the user is in a call (in other words, while the microphones MC2L and MC2R are collecting the uttered voice of the user), the earphone control units S2L and S2R switch the respective valves 70L and 70R to the open state regardless of the operation mode. That is, the valves 70L and 70R are maintained in the open state in the noise cancellation mode, the closed mode of the external sound capture mode, the opened mode of the external sound capture mode, or the OFF mode. Accordingly, when the user is in a call, both the valves 70L and 70R are maintained in the open state, and thus the paths 71 in the housings HOL and HOR communicate with the outside air, whereby a user is prevented from feeling that the voice uttered by himself/herself is muffled even while the earphones 1L and 1R are being worn.

However, when a wind noise is detected in a case the user is in a call and the valves 70L and 70R are in the open state, the earphones 1L and 1R switch the respective valves 70L and 70R to the close state regardless of the type of the operation mode shown in FIG. 12.

On the other hand, while the user is reproducing music (that is, when music signals are acoustically output from the speakers SP1L and SP1R), the earphone control units S2L and S2R switch the respective valves 70L and 70R to the close state if the operation mode is the noise cancellation mode, the OFF mode, and the closed mode of the external sound capture mode. When the operation mode is the opened mode of the external sound capture mode, the earphone control units S2L and S2R switch the respective valves 70L and 70R to the open state. Accordingly, for example, when the user wants to listen to music in a concentrated manner or when the user wants to listen to an ambient sound even during music reproduction, the operation mode is switched to the noise cancellation mode, the closed mode of the external sound capture mode, or the OFF mode to bring the valves 70L and 70R to the close state, whereby the sound quality of music can be improved and the user can comfortably enjoy music listening. In addition, even when the user is not in a call (for example, during music reproduction), the user can listen to the ambient external sound by switching to the opened mode of the external sound capture mode and bringing the valves 70L and 70R into the open state, thereby improving convenience.

However, when a wind noise is detected in a case where the valves 70L and 70R are in the open state because the user is reproducing music and the operation mode is the opened mode of the external sound capture mode, the earphones 1L and 1R switch the respective valves 70L and 70R to the close state.

The external sound capture mode in FIG. 13 includes two sub-modes A and B that can be freely determined by the user as the sub-modes. The sub-mode A of the external sound capture mode is, for example, an operation mode in which sound signals in all the frequency bands are captured, and the same applies to the following description. The sub-mode B of the external sound capture mode is, for example, an operation mode in which a sound signal of a frequency band (for example, a 100 Hz to 1,000 Hz band) of human voice is captured, and the same applies to the following description. The contents of the sub-modes A and B are not limited thereto, and may be freely selected or specified by, for example, a user operation on a dedicated application installed in the smartphone F1. According to the sub-mode A, the earphones 1L and 1R are capable of capturing not only human voice but also sound generated in the surroundings without leakage. On the other hand, according to the sub-mode B, the earphones 1L and 1R are capable of capturing only human voice generated in the surroundings.

A correspondence table TBL3 shown in FIG. 13 defines the states of the valves 70L and 70R corresponding to the reproduction states (specifically, during music reproduction and in a call) and the operation modes (specifically, the noise cancellation mode, the sub-mode A of the external sound capture mode, the sub-mode B of the external sound capture mode, and the OFF mode) of the earphones 1L and 1R. The states of the valves 70L and 70R are the open state and the close state.

When the user is in a call (in other words, while the microphones MC2L and MC2R are collecting the uttered voice of the user), the earphone control units S2L and S2R switch the respective valves 70L and 70R to the open state regardless of the operation mode. That is, the valves 70L and 70R are maintained in the open state in the noise cancellation mode, the sub-mode A of the external sound capture mode, the sub-mode B of the external sound capture mode, or the OFF mode. Accordingly, when the user is in a call, both the valves 70L and 70R are maintained in the open state, and thus the paths 71 in the housings HOL and HOR communicate with the outside air, whereby a user is prevented from feeling that the voice uttered by himself/herself is muffled even while the earphones 1L and 1R are being worn.

However, when a wind noise is detected in a case where the user is in a call and the valves 70L and 70R are in the open state, the earphones 1L and 1R switch the respective valves 70L and 70R to the close state regardless of the type of the operation mode shown in FIG. 13.

On the other hand, while the user is reproducing music (that is, when music signals are acoustically output from the speakers SP1L and SP1R), the earphone control units S2L and S2R switch the respective valves 70L and 70R to the close state if the operation mode is the noise cancellation mode, the OFF mode, and the setting “CLOSE (close)” of the sub-modes A and B of the external sound capture mode. The earphone control units S2L and S2R switch the respective valves 70L and 70R to the open state if the operation mode is “OPEN (open)” of the sub-modes A and B of the external sound capture mode. Accordingly, for example, in a case where the user wants to listen to the external sound of a frequency band (sub-modes A and B) desired to be captured in accordance with the way of use of the user, the user can listen to the ambient external sound by bringing the valves 70L and 70R into the open state, thereby improving convenience. In addition, for example, when the user wants to listen to music in a concentrated manner by blocking external sounds of a frequency (sub-modes A and B) desired to be captured in accordance with the way of use, the user can comfortably enjoy music listening by bringing the valves 70L and 70R into the close state.

However, when a wind noise is detected in a case where the valves 70L and 70R are in the open state because the user is reproducing music and the operation mode is the setting “OPEN (open)” of the sub-modes A and B of the external sound capture mode, the earphones 1L and 1R switch the respective valves 70L and 70R to the close state.

As described above, the earphone 1L, 1R according to the present embodiment includes the housing HOL, HOR having a space therein and having a path capable of ventilation from one end side on an external auditory canal side of a wearer (user) to the other end side on an ambient environment side (outside air side); the valve 70L, 70R accommodated in the housing HOL, HOR and configured to switch the path 71 between an open state and a close state; the microphone MC1L, MC1R disposed on the other end side of the housing HOL, HOR and configured to collect an external sound on the ambient environment side; a second microphone (for example, microphone MC2L, MC2R) disposed on the other end side of the housing HOL, HOR and configured to collect an uttered voice of the wearer; and a control unit (for example, earphone control unit S2L, S2R) configured to control the open state and the close state. The control unit switches the path 71 between the open state and the close state depending on the operation mode (for example, during music reproduction or in a call), and maintains or switches the path 71 in or to the close state when it is determined that the sound signal received by each of the microphone and the second microphone during the operation mode is a wind noise. Accordingly, since it is possible to achieve both the ease of listening to a sound depending on a usage situation of the wearer and the ease of listening in a case where a wind noise is present, the earphone 1L, 1R can not only improve the ease of listening to a sound in accordance with the operation mode but also prevent the user from feeling uncomfortable due to a wind noise because the valve 70L, 70R is brought into the close state even when wind strong enough to generate a wind noise is blown in the surroundings. Accordingly, the earphone 1L, 1R can improve the convenience of the wearer.

When a wind noise is detected in an operation mode in which at least one of the microphone (for example, the microphone MC1L, MC1R) and the second microphone (for example, the microphone MC2L, MC2R) collects the uttered voice of the wearer, the control unit (for example, the earphone control unit S2L, S2R) switches the path 71 from the open state to the close state. Accordingly, when a wind noise is detected in a case where the user is in a call, the earphone 1L, 1R brings the valve 70L, 70R into the close state, and thus it is possible to avoid a situation in which a call is hindered by wind noise.

When no wind noise is detected in an operation mode in which at least one of the microphone (for example, the microphone MC1L, MC1R) and the second microphone (for example, the microphone MC2L, MC2R) collects the uttered voice of the wearer, the control unit (for example, the earphone control unit S2L, S2R) maintains the path 71 in the open state. Accordingly, when no wind noise is detected during a call by the user, the earphone 1L, 1R brings the path 71 (in other words, the valve 70L, 70R) into the open state, and thus the user can be prevented from feeling the voice uttered by himself/herself is muffled and can comfortably make a call.

When a wind noise is detected in a case where the operation mode is the noise cancellation mode and at least one of the microphone (for example, the microphone MC1L, MC1R) and the second microphone (for example, the microphone MC2L, MC2R) is collecting the uttered voice of the wearer, the control unit (for example, the earphone control unit S2L, S2R) switches the path 71 (in other words, the valve 70L, 70R) from the open state to the close state. Accordingly, even in a situation in which a wind noise is detected during a call in the noise cancellation mode, the earphone 1L, 1R bring the valve 70L,70R into the close state, whereby it is possible to prevent a bad influence due to noise generated by wind entering from an air vent (for example, the user feels uncomfortable or it is difficult to hear sound from a speaker).

When a wind noise is detected in a case where the operation mode is the external sound capture mode, the control unit (for example, the earphone control unit S2L, S2R) switches the path 71 (in other words, the valve 70L, 70R) from the open state to the close state. Accordingly, in a situation where a wind noise is detected during the external sound capture mode, the earphone 1L, 1R brings the valve 70L, 70R into the close state respectively, whereby it is possible to avoid a situation where a wind noise is directly heard.

When a wind noise is detected in a case where the operation mode is the opened mode of the external sound capture mode and at least one of the microphone (for example, the microphone MC1L, MC1R) and the second microphone (for example, the microphone MC2L, MC2R) is collecting the uttered voice of the wearer, the control unit (for example, the earphone control unit S2L, S2R) switches the path 71 (in other words, the valve 70L, 70R) from the open state to the close state. Accordingly, in a situation where a wind noise is detected when the user is in a call in the opened mode of the external sound capture mode, the earphone 1L, 1R brings the valve 70L, 70R from the open state to the close state, and thus it is possible to prevent occurrence of difficulty in listening to voice due to the wind noise during the call.

The control unit (for example, the earphone control unit S2L, S2R) switches the path 71 from the open state to the close state when a wind noise is detected in a case where the operation mode is the first sub-mode (for example, the sub-mode A) of the external sound capture mode and the path 71 (in other words, the valve 70L, 70R) is set to the open state, and switches the path 71 from the open state to the close state when a wind noise is detected in a case where the operation mode is the second sub-mode (for example, the sub-mode B) of the external sound capture mode, and the path 71 is set to the open state. Accordingly, for example, in a situation in which a wind noise is detected when the user wants to listen to the external sound of a frequency band (sub-modes A and B) desired to be captured in accordance with the way of use of the user, the valve 70L, 70R is switched from the open state to the close state, whereby a wind noise can be preferentially made difficult to be heard, and it is possible to reduce an uncomfortable impression caused by a wind noise. In addition, for example, in a situation where a wind noise is detected when the user wants to listen to music in a concentrated way by blocking external sounds of a frequency (sub-modes A and B) desired to be captured in accordance with the way of use of the user, the valve 70L, 70R can be brought into the close state, whereby the user can concentrate and comfortably enjoy music listening.

Although an embodiment has been described above with reference to the accompanying drawings, the present disclosure is not limited thereto. It is obvious to those skilled in the art that various changes, modifications, replacements, additions, deletions, and equivalents can be conceived within the scope described in the claims, and it is understood that these also belong to the technical scope of the present disclosure. In addition, the constituent elements in the above embodiment may be freely combined without departing from the spirit of the invention.

### INDUSTRIAL APPLICABILITY

The present disclosure is useful as an earphone, an acoustic control method, and a program for improving convenience for a wearer while achieving both the ease of listening to a sound depending on a usage situation of the wearer and easy hearing of wind noise.

What is claimed is:

1. An earphone comprising:
a housing having a space therein and having a path capable of ventilation from one end side on an external auditory canal side of a wearer to the other end side on an ambient environment side;
a valve accommodated in the housing and configured to switch the path between an open state and a close state;
a first microphone disposed on the other end side of the housing and configured to collect an external sound on the ambient environment side;
a second microphone disposed on the other end side of the housing and configured to collect an uttered voice of the wearer; and
a control unit configured to control the open state and the close state, wherein
the control unit is configured to
switch the path between the open state and the close state in accordance with an operation mode, and
maintain or switch the path in or to the close state in a case where it is determined that a sound signal collected by each of the first microphone and the second microphone during the operation mode is a wind noise.

2. The earphone according to claim 1, wherein
in a case that the wind noise is detected during the operation mode in which at least one of the first microphone and the second microphone collects an uttered voice of the wearer, the control unit switches the path from the open state to the close state.

3. The earphone according to claim 2, wherein
in a case that no wind noise is detected during the operation mode in which at least one of the first microphone and the second microphone collects an uttered voice of the wearer, the control unit is configured to maintain the path in the open state.

4. The earphone according to claim 2, wherein
when the wind noise is detected in a case where the operation mode is a noise cancellation mode and at least one of the first microphone and the second microphone collects an uttered voice of the wearer, the control unit switches the path from the open state to the close state.

5. The earphone according to claim 1, wherein
when the wind noise is detected in a case where the operation mode is an external sound capture mode, the control unit switches the path from the open state to the close state.

6. The earphone according to claim 1, wherein
when the wind noise is detected in a case where the operation mode is an opened mode of an external sound capture mode and at least one of the first microphone and the second microphone collects an uttered voice of the wearer, the control unit switches the path from the open state to the close state.

7. The earphone according to claim 1, wherein
the control unit switches the path from the open state to the close state when the wind noise is detected in a case where the operation mode is a first sub-mode of an external sound capture mode and the path is set to the open state, and
the control unit switches the path from the open state to the close state when the wind noise is detected in a case where the operation mode is a second sub-mode of the external sound capture mode and the path is set to the open state.

8. An acoustic control method for an earphone which includes a housing having a space therein and having a path capable of ventilation from one end side on an external auditory canal side of a wearer to the other end side on an ambient environment side, and a valve accommodated in the housing and configured to switch the path between an open state and a close state, the method comprising:
switching the path between the open state and the close state in accordance with an operation mode; and
maintaining or switching the path in or to the close state when it is determined that a sound signal collected in the operation mode by each of a first microphone disposed on the other end side of the housing and configured to collect an external sound on the ambient environment side and a second microphone configured to collect an uttered voice of the wearer is a wind noise.

9. A computer readable storage medium on which a computer program causing a computer to execute the acoustic control method according to claim 8 is stored.
